(19) United States
(12) Patent Application Publication
(10) Pub. No.: US 2018/0309120 A1
(43) Pub. Date: Oct. 25, 2018

(54) ENVIRONMENT-FRIENDLY BATTERY

(71) Applicant: FENG CHIA UNIVERSITY, Taichung City (TW)

(72) Inventor: KUO-FENG CHIU, Taichung City (TW)

(21) Appl. No.: 15/492,964

(22) Filed: Apr. 20, 2017

(51) Int. Cl. H01M 4/46; H01M 4/587; H01M 2/16; H01M 4/38; H01M 4/62

(52) U.S. Cl. CPC H01M 4/463; H01M 4/466; H01M 4/625; H01M 2/1653; H01M 4/38; H01M 4/587

(57) ABSTRACT

The present invention discloses an environment-friendly battery including a housing, an anode, a cathode, a separator and an electrolyte solution. The anode is composed of a metallic element or alloy. The cathode is composed of a metallic element, a carbon material, or a carbon metal composite material. The separator is composed of a porous polymer material or other porous materials, for example, paper. The electrolyte solution is a metallic ion solution or other solutions containing salts.

### FIELD OF THE INVENTION

The present invention relates to an environment-friendly battery utilizing recycled metal or alloy scrap as electrodes.

### BACKGROUND OF THE INVENTION

With development of technology over the years, metals are widely used in various industries, e.g., vehicle industry, consumer electronics industry or furniture industry, thereby producing more and more waste.

However, large amounts of wastes such as aluminum, magnesium, aluminum alloy, magnesium alloy, or aluminum-magnesium alloy are recyclable. For example, such recyclable metals or alloys can be appropriately used in the battery industry.

Accordingly, an environment-friendly battery capable of reducing waste and conserving the environment is desired.

### SUMMARY OF THE INVENTION

Embodiments of the present invention disclose an environment-friendly battery utilizing recycled metal or alloy scrap as electrodes. Furthermore, the environment-friendly battery utilizes various carbon materials or metals as electrodes together with appropriate electrolyte solutions and separator. This reduces waste and helps to conserve the environment.

Embodiments of the present invention also disclose an environment-friendly battery including a housing, an anode, a cathode, a separator and an electrolyte solution.

The anode, the cathode and the separator there between are disposed in the housing. An electric current generates due to that the electrolyte solution fills up the housing, and that the anode, the cathode and the separator are dipped (or immersed) into the electrolyte solution.

The anode is composed of a metallic element or alloy. The cathode is composed of a metallic element, a carbon material, or a carbon metal composite material. The separator is composed of a porous polymer material or other porous materials, e.g., paper. The electrolyte solution is a metallic ion solution or other solutions containing salts.

### BRIEF DESCRIPTION OF THE DRAWINGS

FIG. 1 is a diagram illustrating an environment-friendly battery in one embodiment of the present invention.

FIG. 2 is a diagram illustrating an environment-friendly battery in another embodiment of the present invention.

### DETAILED DESCRIPTION OF THE INVENTION

An embodiment of the present invention discloses an environment-friendly battery including an electrolyte solution 10, an anode 20, a cathode 30, a housing 40, and a separator 50. The anode 20 is composed of a metallic element or alloy. The cathode 30 is composed of a metallic element, a carbon material, or a carbon metal composite material. The separator 50 is composed of a porous polymer material. The electrolyte solution 10 is a metallic ion solution or other solutions containing salts.

The anode 20, the cathode 30 and the separator 50 there between are disposed in the housing 40. An electric current generates due to that the electrolyte solution 10 fills up the housing 40, and that the anode 20, the cathode 30 and the separator 50 are dipped (or immersed) into the electrolyte solution 10.

In some embodiments of the present invention, the anode 20 is composed of a so-called “anode metal” which can be alternatively formed by aluminum (Al) or magnesium (Mg) scrap having a thickness between 10 μm and 100 cm.

In other embodiments of the present invention, the anode 20 is alternatively formed by alloy scrap, e.g., aluminum or magnesium alloy scrap, or a mixture of metal and/or alloy scrap, each having a thickness between 10 μm and 100 cm. For example, such mixture can be a mixture of aluminum and magnesium scrap, a mixture of aluminum and magnesium alloy scrap, a mixture of aluminum alloy and magnesium scrap, a mixture of aluminum alloy and magnesium alloy scrap.

In some embodiments of the present invention, the cathode 30 utilizes carbon material, metal, or a combination thereof. The carbon material of the cathode is an electrically conductive material such as carbon tube or carbon fiber. Alternatively, the cathode 30 employs copper, nickel, or other appropriate metals capable of inducing an electric potential difference between itself and the anode 20. In another embodiment of the present invention, a carbon-metal composite serves as the cathode 30. The carbon-metal composite is a multi-phase material that is made from two or more materials, e.g., metallic, ceramic or polymeric material, through an appropriate preparation process.

Generally, the composite is made by dispersing a reinforcement material into a matrix serving as the continuous phase. The matrix includes metal and nonmetal matrix. In some embodiments of the present invention, the metal matrix includes, but not limited to, aluminum, magnesium, Al alloy, Mg alloy, or Al—Mg alloy; the nonmetal matrix includes, but not limited to, carbon; and the reinforcement material includes, but not limited to, glass fiber, carbon fiber, boron fiber, aramid fiber, asbestos fiber, silicon carbide fiber, solid particle or a combination thereof.

In other embodiments of the present invention, the cathode 30 alternatively utilizes or also contains a mixed material or a composite material. The mixed material or composite material further comprises an electrically conductive carbon material which is graphene, vapor grown carbon fiber, carbon nanotubes, graphite sheets, electrically conductive graphite, or a combination thereof.

In some embodiments of the present invention, the separator 50 is fabricated by a porous polymer material that can be polyethylene terephthalate, epoxy, phenol resin, bismaleimide, a nylon derivative, polystyrene, polycarbonate, polyethylene, polypropylene, polyethylene terephthalate, vinyl ester resins, acrylonitrile-butadiene-styrene copolymer, polyimide, or polyvinyl chloride.

In some embodiments of the present invention, the electrolyte solution 10 is a metallic ion solution containing sulfate ion, nitrate ion, hydrochloric acid ion, hydroxide ion, hypochlorite ion, acetate ion, or a combination thereof. In other embodiments, the electrolyte solution 10 contains a metal ion that is at least one atom or group of atoms selected from the group consisting of aluminum, beryllium, boron, gallium, indium, silicon, tin, titanium, chromium, iron, cobalt, and lanthanum. In other embodiments, the electrolyte solution 10 contains a salt formed from at least one atom, organic group, or anion that is selected from the group consisting of hydrogen, an alkyl group, an alkenyl group, an aryl group, a benzyl group, an amide group, a fluoride ion, a chloride ion, a bromide ion, an iodide ion, a perchlorate ion, a tetrafluoroborate ion, a hexafluorophosphate ion, a hexafluoroarsenate ion, a perfluoroalkyl sulfonate ion, and a perfluoroalkylsulfonyl imide ion

In some embodiments of the present invention, the housing 40 is manufactured by plastic, aluminum-plastic film, or stainless steel.

### Embodiment 1

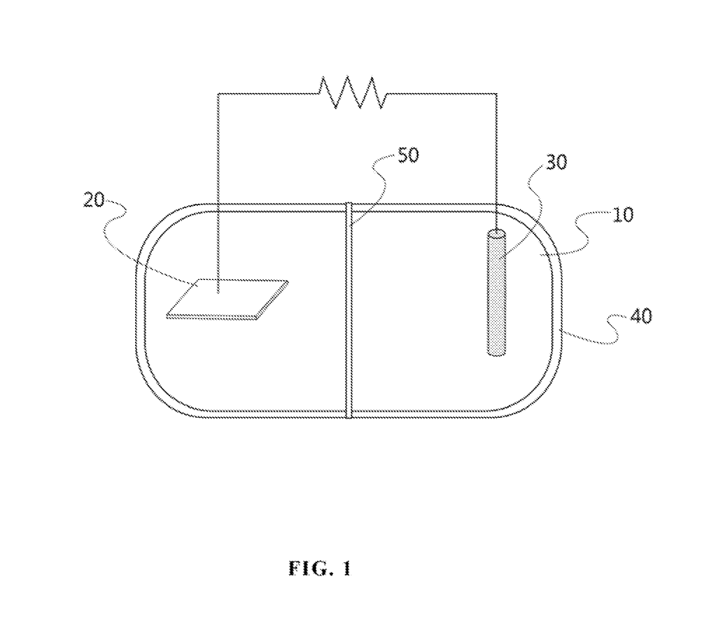

As shown in FIG. 1 which is a diagram illustrating an environment-friendly battery in one embodiment of the present invention, the electrolyte solution 10 is a 1M ferrous sulfate solution or ferric sulfate solution in which the anode 20 and the cathode 30 are totally immersed.

In this embodiment of the present invention, the anode 20 is composed of an alloy foil with a thickness of 0.5 mm that is produced by sequentially cleaning the alloy scrap, sintering the cleaned alloy scrap in nitrogen gas at 700° C., and mechanically thinning the sintered alloy. The alloy scrap that is recycled includes aluminum alloy, magnesium alloy or Al—Mg alloy scrap.

In this embodiment of the present invention, the cathode 30 is a composite composed of an inner carbon tube or carbon rod and an outer electrically-conductive carbon material. The electrically-conductive carbon material, having a thickness of 0.1 mm, is a material of mixing graphene and carbon nanotubes. The housing 40 uses plastic such as polyvinyl chloride. The separator 50 utilizes porous polypropylene.

In this embodiment of the present invention, an electric potential difference ranging from 1.2 V to 2 V is set up between the anode 20 and the cathode 30 so that an electrical current having a current density of 800 mA/cm² passes through the electrolyte solution 10.

### Embodiment 2

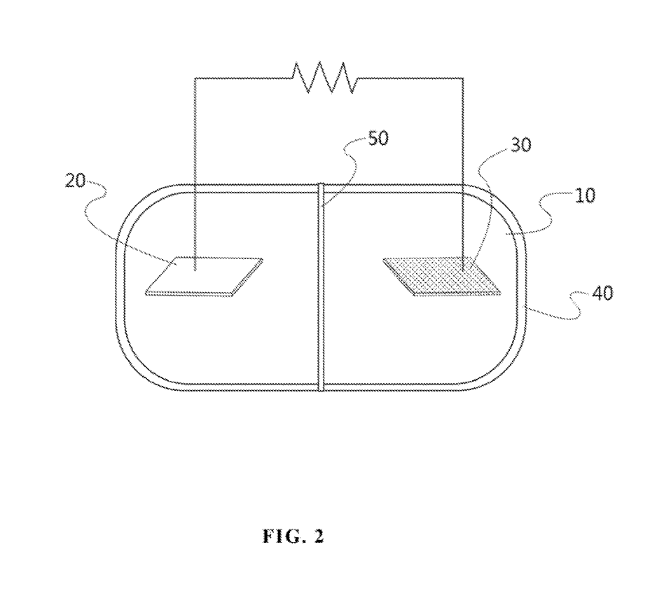

As shown in FIG. 2 which is a diagram illustrating an environment-friendly battery in another embodiment of the present invention, the electrolyte solution 10 is a 1M ferric chloride or ferrous chloride solution in which the anode 20 and the cathode 30 are totally immersed.

In this embodiment of the present invention, the anode 20 is composed of an alloy foil with a thickness of 0.5 mm that is produced by sequentially cleaning the alloy scrap, sintering the cleaned alloy scrap in nitrogen gas at 700° C., and mechanically thinning the sintered alloy. The alloy scrap that is recycled includes aluminum alloy, magnesium alloy or Al—Mg alloy scrap.

In this embodiment of the present invention, the cathode 30 is a composite composed of an inner carbon fiber (cloth) and an outer electrically-conductive carbon material. The electrically-conductive carbon material, having a thickness of 0.1 mm, is a material of mixing graphene and carbon nanotubes. The housing 40 uses aluminum-plastic film. The separator 50 utilizes porous polyimide.

In this embodiment of the present invention, an electric potential difference ranging from 1.2 V to 2 V is set up between the anode 20 and the cathode 30 so that an electrical current having a current density of 900 mA/cm² passes through the electrolyte solution 10.

### Embodiment 3

As shown in FIG. 2 which is a diagram illustrating an environment-friendly battery in yet another embodiment of the present invention, the electrolyte solution 10 is, alternatively, a 1M cupric chloride solution in which the anode 20 and the cathode 30 are totally immersed. In this embodiment of the present invention, the anode 20 is composed of an alloy foil with a thickness of 1 mm that is produced by sequentially cleaning the alloy scrap, sintering the cleaned alloy scrap in nitrogen gas at 800° C., and mechanically thinning the sintered alloy. The alloy scrap that is recycled includes aluminum alloy, magnesium alloy or Al—Mg alloy scrap.

In this embodiment of the present invention, the cathode 30 is a composite composed of an inner copper sheet and an outer electrically-conductive carbon material. The electrically-conductive carbon material, having a thickness of 0.1 mm, is a material of mixing graphene and carbon nanotubes. The housing 40 uses stainless steel. The separator 50 utilizes porous polyimide.

In this embodiment of the present invention, an electric potential difference ranging from 1.2 V to 2.2 V is set up between the anode 20 and the cathode 30 so that an electrical current having a current density of 900 mA/cm² passes through the electrolyte solution 10.

### Embodiment 4

As shown in FIG. 2 which is a diagram illustrating an environment-friendly battery in yet another embodiment of the present invention, the electrolyte solution 10 is, alternatively, a 1M nickel acetate solution in which the anode 20 and the cathode 30 are totally immersed. In this embodiment of the present invention, the anode 20 is composed of an alloy foil with a thickness of 0.5 mm that is produced by sequentially cleaning the alloy scrap, sintering the cleaned alloy scrap in nitrogen gas at 800° C., and mechanically thinning the sintered alloy. The alloy scrap that is recycled includes aluminum alloy, magnesium alloy or Al—Mg alloy scrap.

In this embodiment of the present invention, the cathode 30 is a composite composed of an inner nickel sheet and an outer electrically-conductive carbon material. The electrically-conductive carbon material, having a thickness of 0.1 mm, is a material of mixing graphene and carbon nanotubes that forms an outer layer of carbon fiber. The housing 40 uses stainless steel. The separator 50 utilizes porous polyimide. The housing 40 uses plastic such as polyvinyl chloride. The separator 50 utilizes porous polyimide.

In this embodiment of the present invention, an electric potential difference ranging from 1.2 V to 2.2 V is set up between the anode 20 and the cathode 30 so that an electrical current having a current density of 700 mA/cm² passes through the electrolyte solution 10.

### Embodiment 5

As shown in FIG. 2 which is a diagram illustrating an environment-friendly battery in yet another embodiment of the present invention, the electrolyte solution 10 is, alternatively, a 1M ferrous chloride solution in which the anode 20 and the cathode 30 are totally immersed. In this embodiment of the present invention, the anode 20 is composed of an alloy foil with a thickness of 0.5 mm that is produced by sequentially cleaning the alloy scrap, sintering the cleaned alloy scrap in nitrogen gas at 800° C., and mechanically thinning the sintered alloy. The alloy scrap that is recycled includes aluminum alloy, magnesium alloy or Al—Mg alloy scrap.

In this embodiment of the present invention, the cathode 30 is a composite composed of an inner carbon fiber cloth and an outer electrically-conductive carbon material. The electrically-conductive carbon material, having a thickness of 0.1 mm, is a mixture of graphene and carbon nanotubes. The housing 40 uses stainless steel. The separator 50 utilizes porous polyimide. The housing 40 uses aluminum-plastic film. The separator 50 utilizes porous polyethylene terephthalate.

In this embodiment of the present invention, an electric potential difference ranging from 1.2 V to 2.2 V is set up between the anode 20 and the cathode 30 so that an electrical current having a current density of 750 mA/cm² passes through the electrolyte solution 10.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention.

What is claimed is:

1. An environment-friendly battery, comprising:
a housing;
an anode disposed in the housing;
a cathode disposed in the housing;
a separator disposed between the anode and the cathode; and
an electrolyte solution, filling up the housing, into which the anode, the cathode and the separator are dipped;
wherein the anode is composed of a metallic element or alloy; the cathode is composed of a metallic element, a carbon material, or a carbon metal composite material; and the separator is composed of a porous material.

2. The environment-friendly battery of claim 1, wherein the electrolyte solution is a metallic ion solution that contains sulfate ion, nitrate ion, hydrochloric acid ion, hydroxide ion, hypochlorite ion, acetate ion, or a combination thereof.

3. The environment-friendly battery of claim 1, wherein the electrolyte solution contains a metal ion that is at least one atom or group of atoms selected from the group consisting of aluminum, beryllium, boron, gallium, indium, silicon, tin, titanium, chromium, iron, cobalt, and lanthanum, or contains a salt formed from at least one atom, organic group, or anion that is selected from the group consisting of hydrogen, an alkyl group, an alkenyl group, an aryl group, a benzyl group, an amide group, a fluoride ion, a chloride ion, a bromide ion, an iodide ion, a perchlorate ion, a tetrafluoroborate ion, a hexafluorophosphate ion, a hexafluoroarsenate ion, a perfluoroalkyl sulfonate ion, and a perfluoroalkylsulfonyl imide ion.

4. The environment-friendly battery of claim 1, wherein the carbon material of the cathode is carbon tube or carbon fiber.

5. The environment-friendly battery of claim 1, wherein the metallic element of the cathode is nickel or copper.

6. The environment-friendly battery of claim 1, wherein the cathode is composed of a mixed material or a composite material, further comprising an electrically conductive carbon material which is graphene, vapor grown carbon fiber, carbon nanotubes, graphite sheets, electrically conductive graphite, or a combination thereof.

7. The environment-friendly battery of claim 6, wherein a thickness of the electrically conductive carbon material in the composite material is 0.1 mm.

8. The environment-friendly battery of claim 1, wherein the alloy of the anode uses Al or Mg alloy scrap.

9. The environment-friendly battery of claim 8, wherein an alloy foil is formed by the Al or Mg alloy scrap, serving as the anode.

10. The environment-friendly battery of claim 1, wherein the porous polymer material is a nylon derivative, polystyrene, polycarbonate, polyethylene, polypropylene, polyethylene terephthalate, vinyl ester resins, acrylonitrile-butadiene-styrene copolymer, polyimide, or polyvinyl chloride.
